(19) United States
(12) Patent Application Publication
(10) Pub. No.: US 2026/0046056 A1
(43) Pub. Date: Feb. 12, 2026

(54) ROBUST MULTI-LOCATION JAMMER DETECTION FOR SECURITY AND IOT DEVICES

(71) Applicant: Cypress Semiconductor Corporation, San Jose, CA (US)

(72) Inventors: Eric Simmons, Santa Clara, CA (US); Kiran Uln, Pleasanton, CA (US); Aadhi Vairava Sundaram Kathalingam, Mountain View, CA (US); Amit Shaw, Bangalore (IN)

(73) Assignee: Cypress Semiconductor Corporation, San Jose, CA (US)

(21) Appl. No.: 19/032,398

(22) Filed: Jan. 20, 2025

Related U.S. Application Data
(60) Provisional application No. 63/680,245, filed on Aug. 7, 2024.

(51) Int. Cl. H04K 3/00; G08B 21/18

(52) U.S. Cl. CPC H04K 3/20; G08B 21/182

(57) ABSTRACT

Systems and methods are described herein for implementing a multi-location jammer detection for initiation of an emergency protocol. An example method may include monitoring, by a first wireless device, a noise variance within a bandwidth of the first wireless device. The method includes determining, by a processing device of the first wireless device, that a jammer device is present in response to the noise variance within at least part of the bandwidth exceeding a threshold. The method includes transmitting, to a second wireless device, a distress signal indicating that the jammer device is present and disrupting communication of the first wireless device.

### CROSS REFERENCE TO RELATED APPLICATION(S)

This application claims the benefit of and priority to U.S. Provisional Application Ser. No. 63/680,245, entitled “Multi-Location Jammer Detection for Security in IoT Devices” and filed on Aug. 7, 2024, which is expressly incorporated by reference herein in its entirety.

### TECHNICAL FIELD

Embodiments of the present disclosure generally relate to wireless technology, and in particular, a multi-location jammer detection for initiation of an emergency protocol.

### BACKGROUND

Wireless network protocols such as Wi-Fi enables wireless communication between devices such as computers, smartphones, tablets, and Internet of Things (IoT) devices. Many wireless network protocols may become compromised in the presence of signal jammers. Signal jammers are devices that break and/or overpower communications of wireless devices. Wi-Fi protocol utilizes a listen-before-talk techniques whereby wireless devices first sense or detect radio signals before initiating a transmission. Wi-Fi signals may become severely impacted due to a signal jammer and will not allow Wi-Fi devices to properly communicate with a network, a host device, or other wireless devices.

### BRIEF DESCRIPTION OF THE DRAWINGS

The described embodiments and the advantages thereof may best be understood by reference to the following description taken in conjunction with the accompanying drawings.

These drawings in no way limit any changes in form and detail that may be made to the described embodiments by one skilled in the art without departing from the spirit and scope of the described embodiments.

FIG. 1 is a block diagram that illustrates an example system in accordance with some embodiments of the present disclosure.

FIG. 2 is a diagram that illustrates an example of a jammer device signal disrupting communications of a wireless device in accordance with some embodiments of the present disclosure.

FIG. 3 is a block diagram that illustrates an example system that includes multiple wireless devices, in accordance with some embodiments of the present disclosure.

FIG. 4 is a flow diagram of a method of multi-location jammer detection for initiation of an emergency protocol, in accordance with some embodiments of the present disclosure.

FIG. 5 is a flow diagram of a method of multi-location jammer detection for initiation of an emergency protocol, in accordance with some embodiments of the present disclosure.

FIG. 6 illustrates a diagrammatic representation of a machine in the example form of a computer system within which a set of instructions, for causing the machine to perform any one or more of the methodologies discussed herein for implementing a multi-location jammer detection for initiation of an emergency protocol.

FIG. 7 illustrates a diagrammatic representation of a machine in the example form of a computer system within which a set of instructions, for causing the machine to perform any one or more of the methodologies discussed herein for implementing a multi-location jammer detection for initiation of an emergency protocol.

### DETAILED DESCRIPTION

Wireless communication technologies have become pervasive throughout a wide variety of consumer, healthcare, and industrial applications, including smart home devices, industrial Internet of Things (IoT), health-monitoring devices, smart city devices, energy management, agricultural and environmental monitoring, automobiles, and many others. Power efficiency may be a concern for many of these applications. For example, some wireless devices operate on battery power. Efficient use of power may allow such wireless devices to operate for longer periods of time without charging or replacing the battery.

With an increase in home security, IoT-based security systems are becoming more common. These IoT-based security systems may utilize wireless communication protocols, such as but not limited to Wi-Fi, Bluetooth™ low energy (BLE), or the like. However, the wireless communication protocols of the IoT-based security systems may be disrupted by a jammer device. A jammer device or signal jammer is a device that may break and/or overpower communications of wireless devices. The jammer device or signal jammer may come in a variety of types, such as a continuous jammer, a jammer with a duty cycle, or a frequency sweeping jammer. The continuous jammer constantly emits a jamming signal that continuously disrupts communications of a wireless device. A jammer with a duty cycle emits a jamming signal periodically or non-continuously, where the duty cycle is the ratio of jamming signal duration over a period of time. A frequency sweeping jammer is the shifting of a jamming signal from one frequency to another, where the sweeping motion may disrupt multiple frequencies in a fast series while not disrupting all the multiple frequencies at the same time.

In many use cases, the initiation of wireless communication for IoT-based security systems may be event triggered. For example, one type of event may be a user attempting to access a wireless device such as a doorbell camera, in which case, the wireless device should be able to respond in a timely manner. In such use cases, the presence of a jamming device may severely impact the operations or communications of the doorbell camera. For example, the doorbell camera may utilize Wi-Fi protocol that utilizes a listen-before-talk technique where the doorbell camera senses a radio environment before initiating a transmission, such that the wireless communications of the doorbell camera may be severely impacted due to the jamming signal from the jammer device.

In some instances, security measures are utilized to initiate an emergency protocol and may include a double handshake procedure, where a cloud, network, or network device initiates a check for all client devices or IoT devices. A signal is sent to the client devices or IoT devices requesting a status check and a response from each of the client devices or IoT devices is monitored. The client devices or IoT devices are expected to transmit the response to the status check request and are regularly monitored by the cloud, network, or network device. If the response to the status check request is not received, then the cloud, network, or network device initiates an emergency protocol whereby the cloud, network, or network device assumes that a jammer device is disrupting operation of the client device or IoT device that did not respond. The double handshake procedure may identify client devices or IoT devices that are impacted by a jammer device, but the double handshake procedure may result in an increase of usage of a battery which may reduce the life of the battery, which in turn may significantly impact the operation of the client device or the IoT device. In addition, the double handshake procedure may increase the usage of the available channels or frequencies, especially in instances where there are multiple client devices or IoT devices.

The present disclosure addresses the above-noted and other deficiencies by providing a multi-location jammer detection for initiation of an emergency protocol. In accordance with embodiments disclosed herein, IoT-based security systems may include a wireless device that is a low power device and communicatively coupled to a wireless communication module. The wireless device may monitor a noise variance within a bandwidth of the wireless device. The wireless device may determine that a jammer device is present in response to the noise variance within at least part of the bandwidth exceeding a threshold. The wireless device may transmit a distress signal indicating that the jammer device is present and disrupting communication of the wireless device.

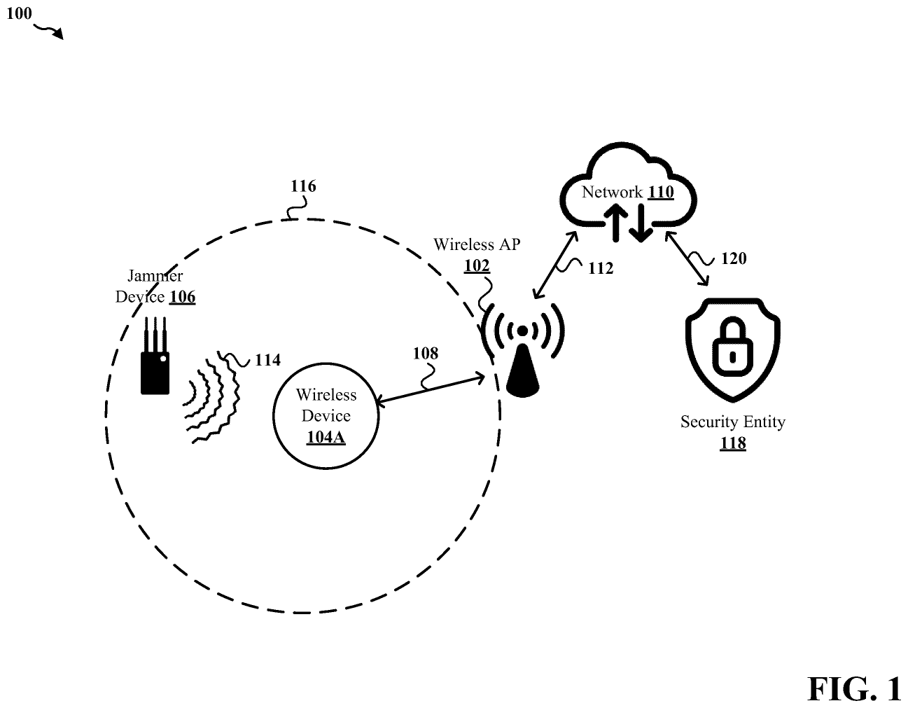

FIG. 1 is a block diagram that illustrates an example system for a multi-location jammer detection for initiation of an emergency protocol, in accordance with some embodiments of the present disclosure. The example system 100 includes a wireless access point (AP) 102 having wireless networking capabilities. The example system 100 includes a wireless device 104A which may be any suitable type of electronic device and may be an edge device (e.g., network endpoint). For example, the wireless device 104A may be an IoT device (e.g., IoT sensor), a smart home device (e.g., smart thermostat, lock, lighting, etc.), a security camera, a health monitoring device, wearable medical sensors, smart cities device (e.g., smart lighting, parking meter, traffic monitor), energy management device (e.g., smart electricity meter), consumer electronics (e.g., television, wireless speaker, etc.), and others.

In some embodiments, the wireless device 104A may be a non-Access Point station (non-AP STA), which refers to a device that is equipped with a wireless network interface controller and uses a Wi-Fi protocol to connect to other devices or networks, but does not have access point capability. An AP is a specialized type of station that serves as a central transmitter and receiver of wireless radio signals. A station that does not have access point capability is typically referred to as non-AP station (non-AP STA). Non-AP stations are typically end devices (e.g., IoT devices) that communicate with a station (e.g., wireless AP 102) to gain network connectivity.

The wireless device 104A includes wireless communication capabilities that enable the wireless device 104A to access one or more wireless networks. The wireless device 104A may use any suitable wireless protocol, including Wi-Fi, Bluetooth, and others. The wireless device 104A may also be configured to operate in accordance with a combination of different protocols. For example, the wireless device 104A may be Wi-Fi and Bluetooth capable.

Additionally, it will be appreciated that although a single wireless module is shown, the wireless device 104A may include two or more wireless devices, each for accessing a different type of wireless networks.

The wireless AP 102 may be configured to communicate with the wireless device 104A. The wireless AP 102 may serve as a central transmitter and receiver of wireless radio signals. The wireless AP 102 may also be communicatively coupled to a network 110 via link 112, which may be a public network (e.g., the Internet), a private network (e.g., a local area network (LAN), or a wide area network (WAN)), or a combination thereof. For example, the network 110 may be an enterprise network of a facility such as a hospital, warehouse, manufacturer, or other business enterprise. The network 110 may also be a public network or a private network. For example, the wireless AP 102 may be a home wireless router connected to the Internet via an Internet service provider. In another example, the wireless AP 102 may be an network device within a private network that provides connectivity to permitted devices within the private network. In some embodiments, the wireless AP 102 may be a wireless repeater that extends the range of the wireless network.

The wireless device 104A may include a processing device configured to cause the wireless device 104A to transition from an inactive mode to an active mode. In the active mode, the wireless device 104A may be turned on and operable such that the wireless device 104A is able communicate with the wireless AP 102 to send and receive data wirelessly. The wireless device 104A is configured to be continuously active and listening for a signal transmitted wirelessly by the wireless AP 102.

The wireless device 104A may include a radio frequency (RF) receiver, a processing device, and memory. The wireless device 104A may receive RF signals and may include circuitry used to receive and decode RF signals. The wireless device 104A may operate at any suitable frequency or range of frequencies, which may be the same as or different from the frequency range of the wireless AP 102.

The processing device of the wireless device 104A may be an application specific integrated circuit (ASIC), a field programmable gate array (FPGA), a microcontroller, a system-on-chip (SoC), etc. The memory of the wireless device 104A may be one or more of a random-access memory (RAM), a solid-state memory (e.g., flash memory), read-only memory (ROM), a cache, etc. In some embodiments, the memory may be an integrated component of the processing device. Additionally, the memory may be a read-only memory, a writable memory, or a combination thereof.

In some embodiments, the wireless device 104A may include a battery, which provides electrical power to operate the RF receiver, processing device, and memory. The battery may be rechargeable or may not be rechargeable. In some embodiments, the wireless device 104A may also be powered by an external energy source such as AC power provided to the wireless device 104A.

The wireless device 104A can receive wireless signals and decode the signals to generate digital data, which is communicated to the processing device. If the wireless device 104A is in an inactive mode, the wireless device 104A exits the inactive mode and enters the active mode and may listen for wireless communications directed to the wireless device 104A. For example, the wireless device 104A may receive a beacon from the wireless AP 102 indicating that data packets are waiting to be transmitted to the wireless device 104A. Wireless communications may then proceed in accordance with the relevant wireless communication protocol. The wireless device 104A may communicate with the wireless AP 102 via communication link 108. For example, the wireless device 104A may receive signals from the wireless AP 102 via the communication link 108. The wireless device 104A may transmit signals to the wireless AP 102 via the communication link 108.

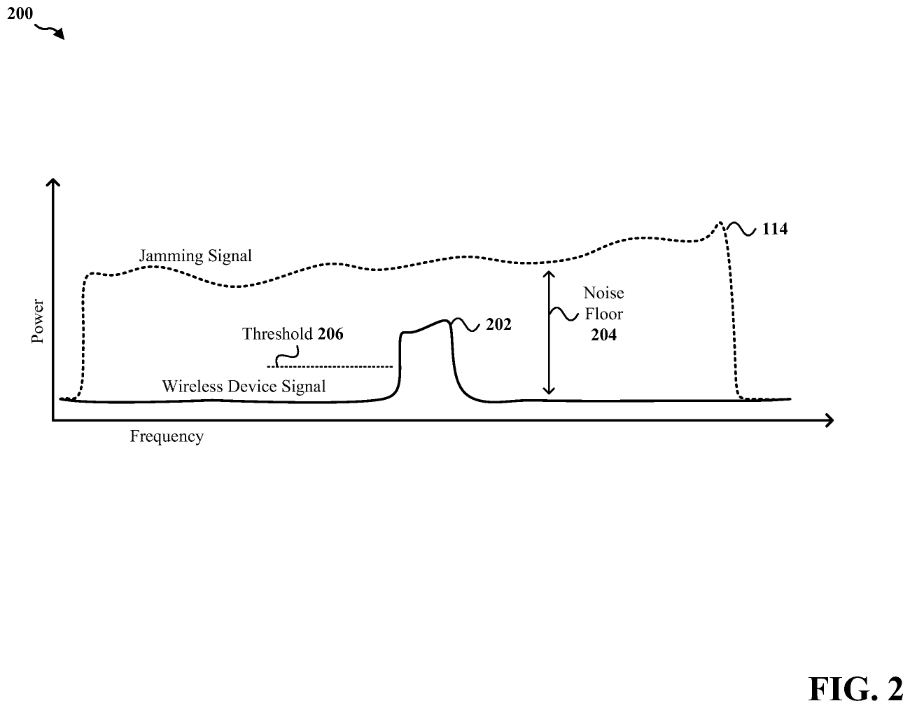

In some embodiments, the communication link 108 between the wireless device 104A and wireless AP 102 may become impacted due to a jammer device 106. For example, the jammer device 106 may transmit a jamming signal 114 which may impact the communication link 108 between the wireless device 104A and wireless AP 102. The jamming signal 114 may impact the communication link 108 due to the jamming signal 114 raising a noise floor 204 to a level that overtakes the signal strength of transmissions from wireless device 104A, as shown for example in diagram 200 of FIG. 2. With reference to FIG. 2, the power or signal strength of the wireless device signal 202 transmitted from the wireless device 104A is less than the power or signal strength of the jamming signal 114, such that the wireless device signal 202 is overpowered by the jamming signal 114. In the example of diagram 200 of FIG. 2, the jamming signal 114 is a continuous jamming signal, such that when the jamming signal is active, the noise floor 204 may significantly rise to a level to overtake the wireless device signal 202. As a result, performance of the wireless device 104A will be heavily impacted by the increase in the noise floor 204. In instances where transmissions from the wireless device 104A are blocked by the jamming signal 114, the transmissions from the wireless device 104A are blocked due to energy detect clear channel assessment (ED-CCA). For example, the wireless device will check to see if there is a channel free or available, but with the presence of the jammer device, the wireless device will detect the jamming signal 114 and will determine that the channel is busy or unavailable; the wireless device will therefore not transmit a signal on the channel. In some instances, the jamming signal 114 may be continuous such that the channel is always busy, thereby preventing the wireless device 104A from ever transmitting to the wireless AP 102.

In the example of diagram 200, the jamming signal 114 is shown as a wideband jamming signal that has a bandwidth greater that covers the entire channel(s) of the transmission bandwidth of the wireless device 104A. However, in some embodiments, the jamming signal 114 may have different bandwidths and may interfere or jam at least a portion of the communication bandwidth (e.g., transmission bandwidth, reception bandwidth) of the wireless device 104A.

In some embodiments, the wireless device 104A may monitor for an increase in the noise floor 204, within the bandwidth of the wireless device 104A, to determine if the rise in noise floor 204 is due to one or more jammer devices 106. Both spatial and temporal variations may be taken into account. If the noise floor 204 increases significantly (e.g., greater than a threshold 206), then the wireless device 104A may be configured to send an alert or a distress signal. The alert or distress signal may be a call out for help based on the wireless device 104A detecting the presence of the jammer device 106. The wireless device 104A may determine that the jammer device 106 is present based on the noise floor 204 increasing above the threshold 206. In some embodiments, the noise floor 204 may increase but may not exceed the threshold 206. In such instances, the jammer device 106 may be present but may be considered a weak jammer device that does not significantly impact or disrupt the communications of the wireless device 104A.

In some embodiments, the alert or distress signal may be transmitted by the wireless device 104A at a maximum transmission power of the wireless device 104A. In some embodiments, the alert or distress signal may be transmitted by the wireless device 104A using different data rates. In some embodiments, the alert or distress signal may be transmitted by the wireless device 104A in different channels or frequency band supported by the wireless AP 102. The wireless device 104A may be configured with the capabilities of the wireless AP 102, such that the wireless device 104A is able to configure the transmission of the alert or distress signal based on the supported capabilities of the wireless AP 102. To transmit the alert or distress signal, the wireless device 104A may temporarily be out of compliance of standard protocol of listen-before-talk. For example, the wireless device 104A may disobey ED-CCA or carrier sense multiple access/collision avoidance (CSMA/CA) as an emergency situation which has been caused by the presence of the non-compliant jammer device 106. The wireless device 104A disobeying ED-CCA or CSMA/CA is a temporary occasion and does not cause any violation of Federal Communications Commission (FCC) standards, such that the transmission of the alert or distress signal by the wireless device 104A is compliant within FCC requirements. The transmission of the alert or distress signal is intended to notify the wireless AP 102 or other network entity that the jammer device 106 is present or in the vicinity of the wireless device 104A and is disrupting and/or interfering with the communications of the first wireless device 104A.

In some embodiments, the wireless device 104A may continue to transmit the alert or distress signal until the jammer device 106 is no longer disrupting the wireless device 104A. For example, the wireless device 104A may monitor the noise floor 204 while transmitting the alert or distress signal. If the wireless device 104A determines that the noise floor 204 has dropped below the threshold 206, then the wireless device 104A may stop transmitting the alert or distress signal. In some embodiments, the wireless device 104A may initiate a timer upon transmitting the alert or distress signal. The wireless device 104A may continue transmitting the alert or distress signal until the expiration of the timer. The wireless device 104A transmitting the alert or distress signal based on the timer may allow for the wireless device 104A to preserve battery life in instances where the wireless device 104A is only powered by a battery.

In some embodiments, the alert or distress signal may include location information of the wireless device 104A or the jammer device 106. For example, the alert of distress signal may indicate the location of the wireless device 104A or may include a region 116 which includes an estimated location of the jammer device 106. In some embodiments, as shown for example in diagram 100 of FIG. 1, the region 116 may correspond to a coverage area of wireless communications for the wireless device 104A, such that wireless communication of the wireless device 104A may be impacted when the jammer device 106 is transmitting the jamming signal 114 within the region 116. The wireless device 104A may have a known coverage area based on the transmit or receive properties of the wireless device 104A, such that disruption of communications of the wireless device 104A from the jammer device 106 may occur due to the jammer device 106 being within the region 116 or the known coverage area of the wireless device 104A. In some embodiments, the location of the wireless device 104A may be known or preconfigured (e.g., static), or the wireless device 104A may include a global positioning system (GPS) component that can identify the coordinates of the wireless device 104A based on the GPS component.

The wireless AP 102 may receive the alert or distress signal from the wireless device 104A. The wireless AP 102, in response to receipt of the alert or distress signal, determines that the jammer device 106 is present or in the vicinity of the wireless device 104A and is disrupting the communications of the wireless device 104A. The wireless AP 102 may transmit, to a security entity 118, a notification signal indicating that the jammer device 106 is present or in the vicinity of the wireless device 104A and disrupting the communication of the wireless device 104A. The wireless AP 102 determines that the jammer device 106 is disrupting communications of the wireless device 104A based on receipt of the alert or distress signal, as well as the manner in which the alert or distress signal was transmitted by the wireless device 104A. For example, the alert or distress signal may be transmitted by the wireless device 104A based on at least one of a maximum transmission power of the wireless device 104A, a reduced periodicity in comparison to a normal operation of the wireless device 104A, different data rates supported by the wireless AP 102, or different channels or frequency bands supported by the wireless AP 102. The wireless AP 102 receiving the alert or distress signal in any of such configurations may further indicate that the jammer device 106 is disrupting the wireless device 104A.

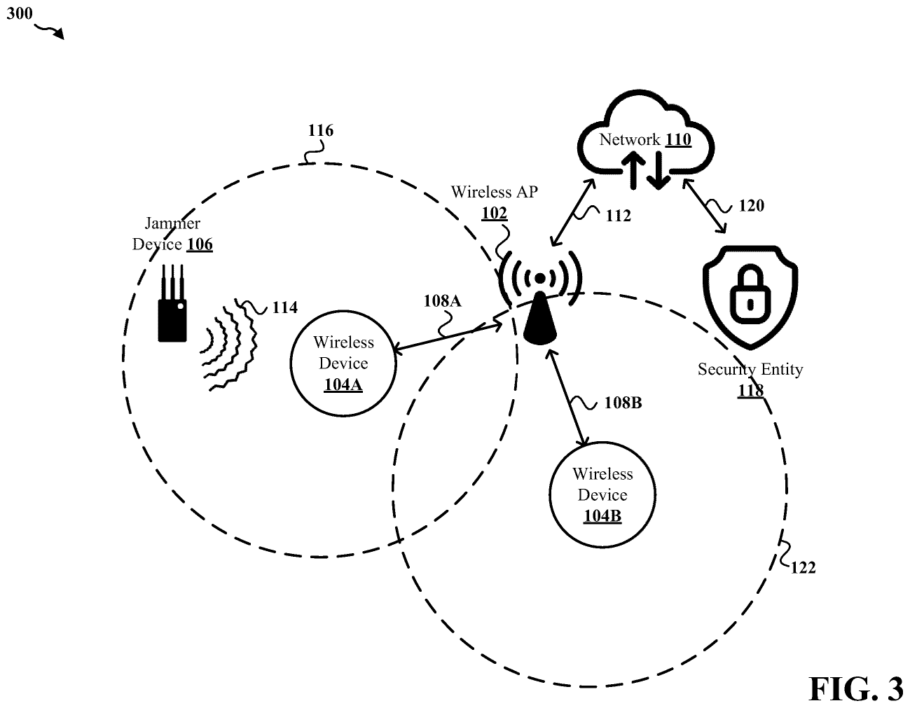

The wireless AP 102 may transmit the notification signal to the security entity 118 using a first link 112 via network 110. The network 110 may provide the notification signal, from the wireless AP 102, to the security entity 118 via a second link 120. In some embodiments, the wireless AP 102 may transmit the notification signal to the security entity 118 via a wired connection via network 110, such that the first link 112 comprises the wired connection. The second link 120 may comprise a wired or wireless connection between the security entity 118 and the network 110. The security entity 118 may be an entity that may cause an investigation of the region 116 based on the information within the notification signal from the wireless device 104A that reported the possible location of the jammer device 106. In some embodiments, as shown for example in diagram 300 of FIG. 3, the possible location of the jammer device 106 may be determined based on which wireless device from a plurality of wireless devices is being disrupted by the jammer device 106. For example, the diagram 300 shows an example including multiple wireless devices (e.g., 104A, 104B) where each wireless device has a separate communication link (e.g., 108A, 108B) with the wireless AP 102, and each wireless device having separate regions (e.g., 116, 122) or known coverage areas. In such example, the jammer device 106 is within region 116 and the jamming signal 114 from jammer device 106 is disrupting the communications of wireless device 104A. The wireless device 104A may be attempting to transmit the alert or distress signal but may be overpowered by the jamming signal 114. However, the wireless device 104B may not be disrupted by the jamming signal 114 from the jammer device 106, due in part to the jammer device 106 not being within region 122, such that the wireless device 104B maintains normal operation. In such instances, the locations of the respective wireless devices (e.g., 104A, 104B) may be known locations, such that the wireless AP 102 may determine the possible location of the jammer device 106 based on which wireless device is being disrupted by the jammer device 106. The wireless AP 102 may include such information in the notification signal transmitted to the security entity 118 to narrow down the area of investigation of locating the jammer device 106.

In some embodiments, the jamming signal 114 from the jammer device 106 may disrupt the wireless AP 102. In such instances, the wireless AP 102 may transmit the notification signal to the security entity 118 without receiving the alert or distress signal from the wireless device 104A. For example, the wireless AP 102 may monitor the noise floor 204, similarly as the wireless device 104A. The wireless AP 102 may determine whether the jammer device 106 is present or in the vicinity of the wireless AP 102 based on the noise floor 204 exceeding the threshold. If the wireless AP 102 measures that the noise floor 204 exceeds the threshold, then the wireless AP 102 determines that the jammer device 106 is present and disrupting communications of the wireless AP 102 or the wireless device 104A. The wireless AP 102 may determine that the jammer device 106 is present based on the noise floor 204 within at least part of an operational bandwidth of the wireless AP 102 exceeds the threshold. The operational bandwidth of the wireless AP 102 may be the same or different than that of the wireless device 104A, such that the wireless AP 102 may detect jamming signals 114 that are not detected by the wireless device 104A. The wireless AP 102 may identify the region 116 as the possible location of the jammer device 106 based, in part, on the lack of reception of transmissions from the wireless device 104A or based on a known coverage pattern of the wireless AP 102. For example, as discussed above, the region 116 may correspond to the known wireless coverage area of the wireless device 104A. The lack of reception of transmissions from the wireless device 104A, at the wireless AP 102, may be indicative of the jammer device 106 being within the region 116 and transmitting the jamming signal 114, thereby raising the noise floor at the wireless device 104A and disrupting wireless communications at the wireless device 104A. The notification signal may include the possible location of the jammer device 106 as being within the coverage area of the impacted wireless device(s), the location of the wireless AP 102, or the location of wireless device(s) that may be disrupted by the jammer device 106. The wireless AP 102 may transmit the notification signal to the security entity 118 via a wireless or wired connection. In instances where the jammer device 106 severely disrupts wireless communications of the wireless AP 102, the wireless AP 102 may transmit the notification signal to the security entity 118 via the wired connection.

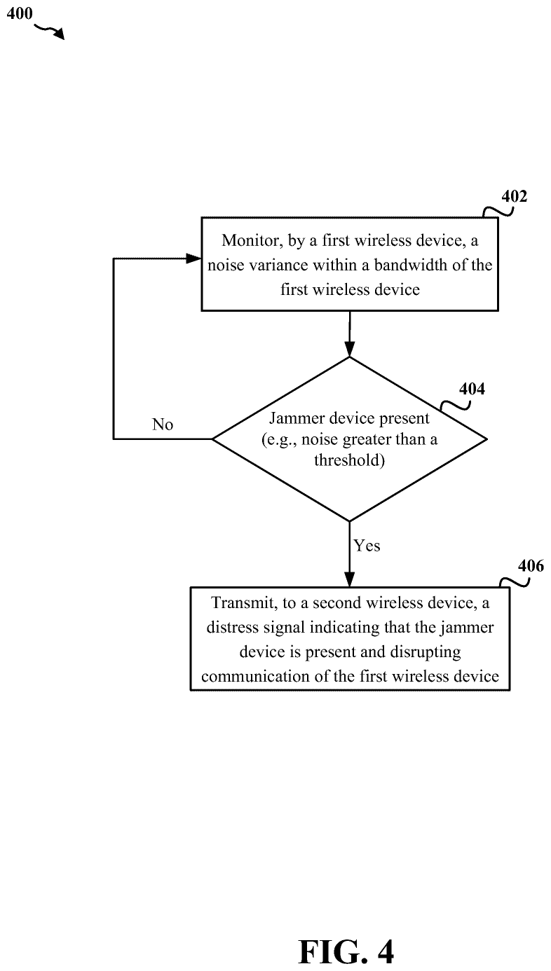

FIG. 4 is a flow diagram of a method 400 for a multi-location jammer detection for initiation of an emergency protocol at a first wireless device in accordance with some embodiments of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by the wireless device 104A shown in FIG. 1 or one of the wireless devices 104A-104B shown in FIG. 3.

At block 402, the first wireless device may monitor a noise variance within a bandwidth of the first wireless device. The noise variance is measured based on at least one of time, bandwidth of the first wireless device, or absolute power in view of a threshold. The noise variance may be measured by the first wireless device.

At block 404, the first wireless device determines whether a jammer device is present. The first wireless device determines whether the jammer device is present based on the noise variance. For example, the first wireless device determines whether the jammer device is present in response to the noise variance within at least part of the bandwidth exceeding a threshold. In some embodiments, a jammer signal from the jammer device may comprise a jammer type signature, wherein the jammer type signature is a non-data communication signal. In some embodiments, if the noise variance is does not exceed the threshold (e.g., No branch), then the first wireless device determines that a jammer device is not present and may continue monitoring the noise variance within the bandwidth of the first wireless device. In some embodiments, the noise variance may increase due in part to a jammer device but may not exceed the threshold. In such instances, the jammer device may be considered a weak jammer device and does not impact operation of the first wireless device. In some embodiments, if the noise variance exceeds the threshold (e.g., Yes branch), then the first wireless device determines that the jammer device is present and may proceed to 406. The noise variance exceeding the threshold may disrupt operation or communications of the first wireless device.

At block 406, the first wireless device transmits a distress signal indicating that the jammer device is present and is disrupting communication of the first wireless device. The first wireless device may transmit the distress signal to a second wireless device. In some embodiments, the distress signal is transmitted at a maximum transmission power of the first wireless device and at a reduced periodicity in comparison to a normal operation. In some embodiments, the distress signal is transmitted at different data rates and in different channels or frequency bands supported by the second wireless device. In some embodiments, the distress signal comprises a location of the first wireless device and a region of a location of the jammer device. In some embodiments, transmission of the distress signal may be maintained based on a timer. For example, the first wireless device may continue with transmission of the distress signal stops until an expiration of the timer. In some embodiments, transmission of the distress signal may be maintained based on measurement of the noise variance. For example, the first wireless device may stop transmission of the distress signal in response to measurement of the noise variance within the bandwidth of the first wireless device as being less than the threshold.

The method 400 illustrates example functions used by various embodiments. Although specific function blocks (“blocks”) are disclosed in method 400, such blocks are examples. That is, embodiments are well-suited to performing various other blocks or variations of the blocks recited in method 400. It is appreciated that the blocks in method 400 may be performed in an order different than presented, and that not all of the blocks in method 400 may be performed.

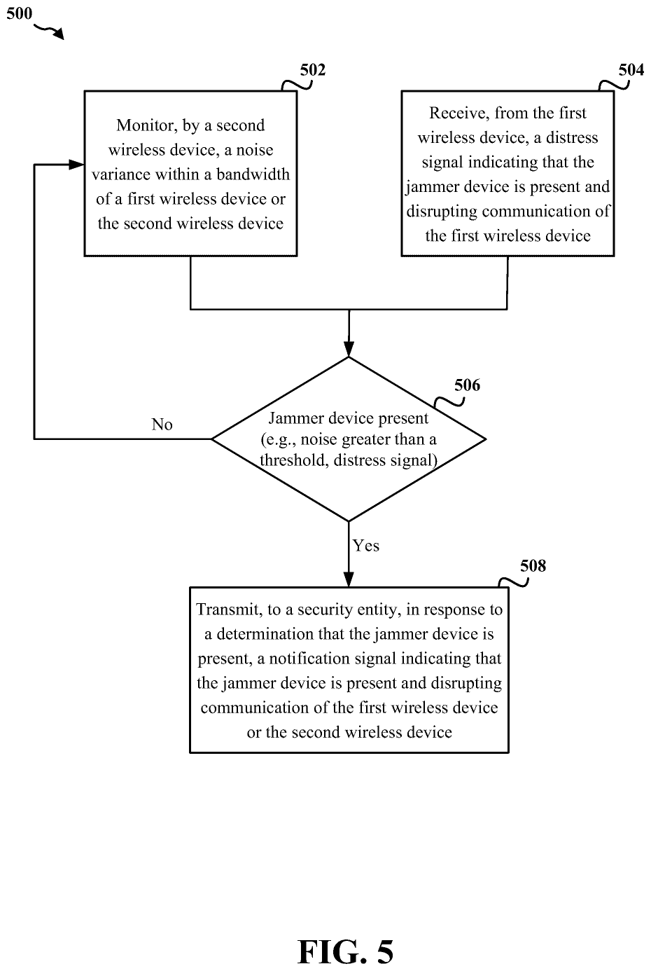

FIG. 5 is a flow diagram of a method 500 for a multi-location jammer detection for initiation of an emergency protocol at a second wireless device in accordance with some embodiments of the present disclosure. The method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by the wireless AP 102 shown in FIG. 1 or 3.

At block 502, the second wireless device may monitor a noise variance within a bandwidth of a first wireless device or the second wireless device. The first wireless device is associated with the second wireless device, such that the first wireless device and the second wireless device communicate with each other. The noise variance is measured based on at least one of time, bandwidth of the first wireless device or the second wireless device, or absolute power in view of a threshold. The noise variance may be measured by the second wireless device.

At block 504, the second wireless device may optionally receive, from a first wireless device, a distress signal. The distress signal may indicate that a jammer device is present and disrupting communication of the first wireless device. In some embodiments, the distress signal is transmitted at a maximum transmission power of the first wireless device and at a reduced periodicity in comparison to a normal operation. In some embodiments, the distress signal is transmitted at different data rates and in different channels or frequency bands of the second wireless device. In some embodiments, the distress signal indicates a location of the first wireless device and a region of a location of the jammer device.

At block 506, the second wireless device determines whether a jammer device is present. The second wireless device determines whether the jammer device is present based at least on the noise variance exceeding a threshold or receipt of a distress signal from the first wireless device. In some embodiments, a determination that the jammer device being present is based on the noise variance within at least part of the bandwidth exceeding the threshold. For example, the second wireless device may determine whether the jammer device is present in response to the noise variance within at least part of the bandwidth exceeding a threshold. In some embodiments, a jammer signal from the jammer device may comprise a jammer type signature, wherein the jammer type signature is a non-data communication signal. In some embodiments, if the noise variance is does not exceed the threshold (e.g., No branch), then the second wireless device determines that a jammer device is not present and may continue monitoring the noise variance within the bandwidth of the first wireless device or the second wireless device. In some embodiments, the noise variance may increase due in part to a jammer device but may not exceed the threshold. In such instances, the jammer device may be considered a weak jammer device and does not impact operation of the first wireless device or the second wireless device. In some embodiments, if the second wireless device does not receive the distress signal from the first wireless device (e.g., No branch), then the second wireless device determines that a jammer device is not present and may continue monitoring the noise variance within the bandwidth of the first wireless device or the second wireless device. In some embodiments, if the noise variance exceeds the threshold or the second wireless device receives the distress signal from the first wireless device (e.g., Yes branch), then the second wireless device determines that the jammer device is present and may proceed to 508. The noise variance exceeding the threshold may disrupt operation or communications of the first wireless device or the second wireless device, while reception of the distress signal is an indication that the jammer device is disrupting operation or communications of the first wireless device.

At block 508, the second wireless device transmits a notification signal to a security entity. The notification signal may be transmitted by the second wireless device to the security entity in response to a determination that the jammer device is present (e.g., noise greater than the threshold, receipt of distress signal). The notification signal indicates that the jammer device is present and disrupting communication of the first wireless device or the second wireless device. In some embodiments, the notification signal comprises a location of the first wireless device, the second wireless device, or a region of a location of the jammer device. In some embodiments, the notification signal is transmitted by the second wireless device to the security entity over a wired connection. For example, the second wireless device may comprise a wireless connection to a network server, such that the notification signal is transmitted via the wired connection based in part on the jammer device disrupting operation or communication of the first wireless device or the second wireless device.

The method 500 illustrates example functions used by various embodiments. Although specific function blocks (“blocks”) are disclosed in method 500, such blocks are examples. That is, embodiments are well-suited to performing various other blocks or variations of the blocks recited in method 500. It is appreciated that the blocks in method 500 may be performed in an order different than presented, and that not all of the blocks in method 400 may be performed.

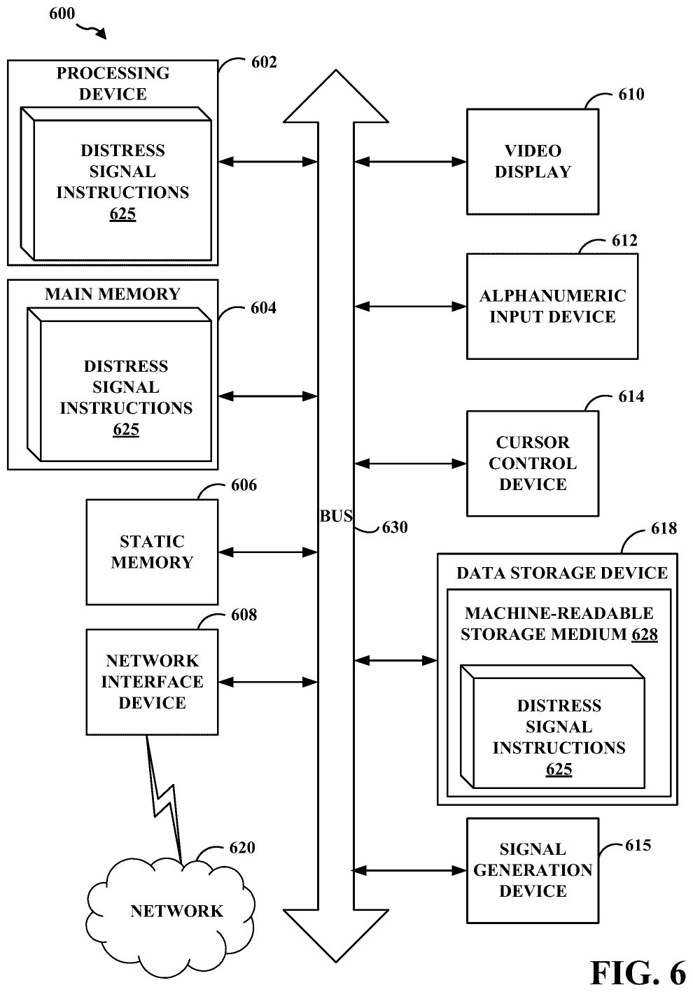

FIG. 6 illustrates a diagrammatic representation of a machine in the example form of a computer system 600 within which a set of instructions, for causing the machine to perform one or more of the methodologies discussed herein for a multi-location jammer detection for initiation of an emergency protocol. More specifically, the machine may monitor, by a first wireless device, a noise variance within a bandwidth of the first wireless device; determine, by a processing device of the first wireless device, that a jammer device is present in response to the noise variance within at least part of the bandwidth exceeding a threshold; and transmit, to a second wireless device, a distress signal indicating that the jammer device is present and disrupting communication of the first wireless device.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 600 may further include a network interface device 608 which may communicate with a network 620. The computing system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and a signal generation device 615 (e.g., a speaker). In some embodiments, the video display unit 610, the alphanumeric input device 612, and the cursor control device 614 may be combined into a single component or device (e.g., an LCD touch screen).

Processing device 602 represents one or more general-purpose processing devices such as a microprocessor, central processing unit, or the like. More particularly, the processing device 602 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), a network processor, or the like. The processing device 602 is configured with distress signal instructions 625, for performing the operations and steps discussed herein. For example, the distress signal instructions 625 may include instructions for a multi-location jammer detection for initiation of an emergency protocol.

The data storage device 618 may include a machine-readable storage medium 628 storing distress signal instructions (e.g., software) embodying any one or more of the methodologies of functions described herein. The distress signal instructions 625 may also reside, completely or partially, within the main memory 604 or within the processing device 602 during execution thereof by the computer system 600; the main memory 604 and the processing device 602 also constituting machine-readable storage media. The distress signal instructions 625 may further be transmitted or received over a network 620 via the network interface device 608.

The machine-readable storage medium 628 may also be used to store the distress signal instructions 625 to perform a method for a multi-location jammer detection for initiation of an emergency protocol, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, a magnetic storage medium (e.g., floppy diskette); an optical storage medium (e.g., CD-ROM); a magneto-optical storage medium, a read-only memory (ROM), random-access memory (RAM), erasable programmable memory (e.g., EPROM and EEPROM), flash memory, or another type of medium suitable for storing electronic instructions.

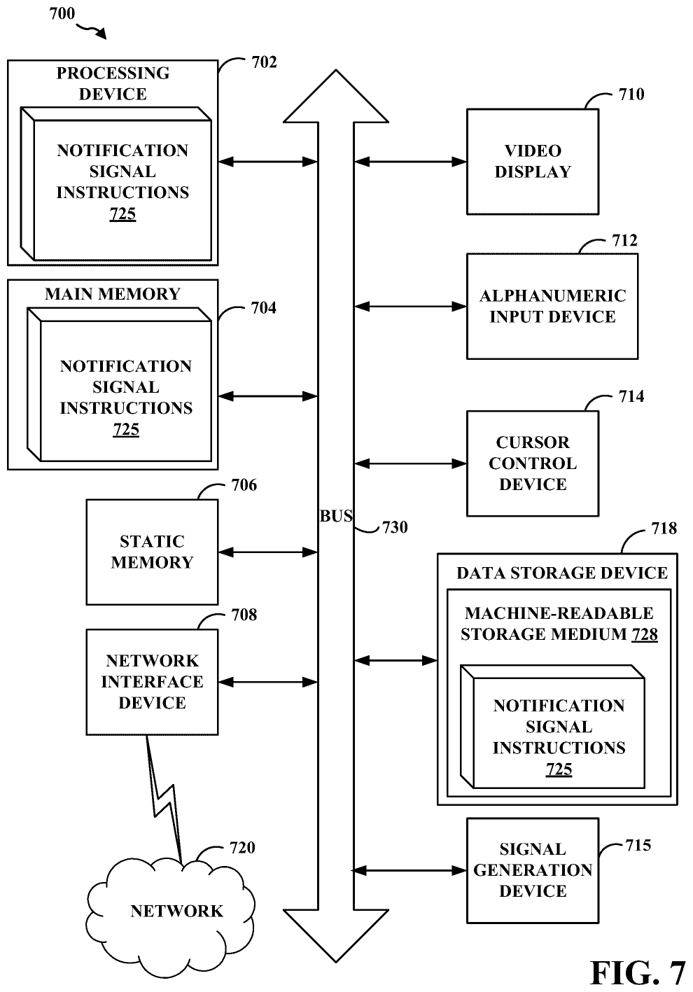

FIG. 7 illustrates a diagrammatic representation of a machine in the example form of a computer system 700 within which a set of instructions, for causing the machine to perform one or more of the methodologies discussed herein for a multi-location jammer detection for initiation of an emergency protocol. More specifically, the machine may monitor, by a second wireless device, a noise variance within a bandwidth of a first wireless device or the second wireless device, wherein the first wireless device is associated with the second wireless device; determine, by a processing device of the second wireless device, whether a jammer device is present based at least on the noise variance exceeding a threshold or receipt of a distress signal from the first wireless device; and transmit, to a security entity, in response to a determination that the jammer device is present, a notification signal indicating that the jammer device is present and disrupting communication of the first wireless device or the second wireless device.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 700 may be representative of a server.

The exemplary computer system 700 includes a processing device 702, a main memory 704 (e.g., read-only memory (ROM), flash memory, dynamic random access memory (DRAM), a static memory 706 (e.g., flash memory, static random access memory (SRAM), etc.), and a data storage device 718 which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 700 may further include a network interface device 708 which may communicate with a network 720. The computing system 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and a signal generation device 715 (e.g., a speaker). In some embodiments, the video display unit 710, the alphanumeric input device 712, and the cursor control device 714 may be combined into a single component or device (e.g., an LCD touch screen).

Processing device 702 represents one or more general-purpose processing devices such as a microprocessor, central processing unit, or the like. More particularly, the processing device 702 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), a network processor, or the like. The processing device 702 is configured with notification signal instructions 725, for performing the operations and steps discussed herein. For example, the notification signal instructions 725 may include instructions for a multi-location jammer detection for initiation of an emergency protocol.

The data storage device 718 may include a machine-readable storage medium 728 storing notification signal instructions (e.g., software) embodying any one or more of the methodologies of functions described herein. The notification signal instructions 725 may also reside, completely or partially, within the main memory 704 or within the processing device 702 during execution thereof by the computer system 700; the main memory 704 and the processing device 702 also constituting machine-readable storage media. The notification signal instructions 725 may further be transmitted or received over a network 720 via the network interface device 708.

The machine-readable storage medium 728 may also be used to store the notification signal instructions 725 to perform a method for a multi-location jammer detection for initiation of an emergency protocol, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, a magnetic storage medium (e.g., floppy diskette); an optical storage medium (e.g., CD-ROM); a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the present disclosure, including what is described in the Abstract, is not intended to be exhaustive or to limit the present disclosure to the precise forms disclosed. While specific implementations of, and examples for, the present disclosure are described herein for illustrative purposes, various equivalent modifications are possible within the scope of the present disclosure, as those skilled in the relevant art will recognize. The words “example” or “exemplary” are used herein to mean serving as an example, instance, or illustration. Any embodiment or design described herein as “example” or “exemplary” is not necessarily to be construed as preferred or advantageous over other embodiments or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “monitoring,” “determining,” “transmitting,” “receiving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S. C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
monitoring, by a first wireless device, a noise variance within a bandwidth of the first wireless device;
determining, by a processing device of the first wireless device, that a jammer device is present in response to the noise variance within at least part of the bandwidth exceeding a threshold; and
transmitting, to a second wireless device, a distress signal indicating that the jammer device is present and disrupting communication of the first wireless device.

2. The method of claim 1, wherein the distress signal is transmitted at a maximum transmission power of the first wireless device and at a reduced periodicity in comparison to a normal operation.

3. The method of claim 1, wherein the distress signal is transmitted at different data rates and in different channels or frequency bands of the second wireless device.

4. The method of claim 1, wherein the distress signal comprises a location of the first wireless device and a region of a location of the jammer device.

5. The method of claim 1, wherein the noise variance is measured based on at least one of time, the bandwidth of the first wireless device, or absolute power in view of the threshold.

6. The method of claim 1, wherein transmission of the distress signal is maintained based on at least one of:
a timer, such that the transmission of the distress signal stops upon expiration of the timer, or
a measurement of the noise variance within the bandwidth of the first wireless device being less than the threshold.

7. The method of claim 1, wherein a jammer signal from the jammer device comprises a jammer type signature corresponding to a non-data communication signal.

8. A system, comprising:
a memory; and
a processing device, operatively coupled to the memory, configured to:
monitor a noise variance within a bandwidth of a first wireless device;
determine that a jammer device is present in response to the noise variance within at least part of the bandwidth exceeding a threshold; and
transmit, to a second wireless device, a distress signal indicating that the jammer device is present and disrupting communication of the first wireless device.

9. The system of claim 8, wherein the distress signal is transmitted based on at least one of:
a maximum transmission power of the first wireless device,
a reduced periodicity in comparison to a normal operation of the first wireless device,
different data rates of the second wireless device, or
different channels or frequency bands of the second wireless device.

10. The system of claim 8, wherein the distress signal comprises a location of the first wireless device and a possible location of the jammer device.

11. A method, comprising:
monitoring, by a second wireless device, a noise variance within a bandwidth of a first wireless device or the second wireless device, wherein the first wireless device is associated with the second wireless device;
determining, by a processing device of the second wireless device, whether a jammer device is present based at least on the noise variance exceeding a threshold or receipt of a distress signal from the first wireless device; and
transmitting, to a security entity, in response to determining that the jammer device is present, a notification signal indicating that the jammer device is present and disrupting communication of the first wireless device or the second wireless device.

12. The method of claim 11, wherein determining that the jammer device is present is based on the noise variance within at least part of the bandwidth exceeding the threshold.

13. The method of claim 11, wherein the notification signal comprises a location of the first wireless device, the second wireless device, or a region of a location of the jammer device.

14. The method of claim 11, wherein the notification signal is transmitted over a wired connection.

15. The method of claim 11, wherein to determine whether the jammer device is present further comprising:
receiving, from the first wireless device, the distress signal indicating that the jammer device is present and disrupting communication of the first wireless device.

16. The method of claim 15, wherein the distress signal is transmitted at a maximum transmission power of the first wireless device and at a reduced periodicity in comparison to a normal operation.

17. The method of claim 15, wherein the distress signal is transmitted at different data rates and in different channels or frequency bands of the second wireless device.

18. The method of claim 15, wherein the distress signal indicates a location of the first wireless device and a region of a location of the jammer device.

19. A system, comprising:
a memory; and
a processing device, operatively coupled to the memory, configured to:
monitor a noise variance within a bandwidth of a first wireless device or a second wireless device, wherein the first wireless device is associated with the second wireless device;
determine whether a jammer device is present based at least on the noise variance exceeding a threshold or receipt of a distress signal; and
transmit, to a security entity, in response to a determination that the jammer device is present, a notification signal indicating that the jammer device is present and disrupting communication of the first wireless device or the second wireless device.

20. The system of claim 19, wherein to determine whether the jammer device is present, the processing device is configured to:
receive the distress signal indicating that the jammer device is present and disrupting communication of the first wireless device.
